(19) United States
(12) Patent Application Publication
(10) Pub. No.: US 2002/0089913 A1
(43) Pub. Date: Jul. 11, 2002

(54) Light source device for an optical head apparatus and method relating thereto

(76) Inventors: Katsuya Moriyama, Nagano (JP); Hisahiro Ishihara, Nagano (JP); Masao Takemura, Nagano (JP)

Correspondence Address: REED SMITH LLP, 375 Park Avenue, New York, NY, 10152, US

(21) Appl. No.: 09/908,345

(22) Filed: Jul. 18, 2001

(30) Foreign Application Priority Data
Jul. 21, 2000 (JP) 2000-220710
Sep. 13, 2000 (JP) 2000-277393

(51) Int. Cl. G11B 7/125

(52) U.S. Cl. 369/53.26; 369/121

(57) ABSTRACT

A light source device for an optical head apparatus comprises at least one laser diode chip and a semiconductor substrate integral with the laser chip. The light source device is formed in a recess of the semiconductor substrate for aligning the laser diode chip on a surface of the semiconductor substrate by a semiconductor processing technique. The recess comprises a first side surface for defining a laser beam emitted from the laser diode chip in an optical axial direction and a second side surface for defining a direction perpendicular to the optical axial direction.

### CROSS REFERENCE TO RELATED APPLICATIONS

This application claims priority of Japanese Application Nos. 2000-220710 filed Jul. 21, 2000 and 2000-277393 filed Sep. 13, 2000, the complete disclosure of which are hereby incorporated by reference.

### BACKGROUND OF THE INVENTION

a) Field of the Invention

The present invention relates to an optical head apparatus used for recording/reproducing in optical data storage media. Exemplary optical data storage media are CDs (compact disks) and DVDs (digital versatile disks). In particular, the present invention relates to a method of aligning a laser diode chip of a light source device in an optical head apparatus to record and reproduce data on optical data storage media.

b) Description of the Related Art

Popular optical data storage media (e.g. CD, DVD) comprise substrates of different thicknesses and densities. Laser beams of different wavelengths are typically used for recording/reproducing data on such optical data storage media. For example, DVDs require a laser beam with a wavelength of 650 nm for recordation and reproduction of data; CD-R (Compact Disk Recordable) requires a laser beam with a wavelength of 780 nm reflecting its low CD-R reflection factor of around 650 nm.

A dual wavelength optical head apparatus, having a light source emitting a laser beam with a wavelength of 650 nm and/or 780 nm, is typically used for DVD data reproduction and CD-R data recordation/reproduction. A popular type of light source device used for the dual-wavelength optical head apparatus is represented by a “monolithic” type, characterized by a construction of a light receiving and emitting unit for integrating laser diodes and photodetectors: Monolithic type light source devices, comprise a first type wherein two laser diode chips are mounted on one semiconductor chip; and a second wherein hybrid type, two laser diode chips are mounted on one semiconductor chip.

A laser diode chip must be aligned accurately on a substrate. For example, one alignment technique which a light source device employs includes a passive align method, in which a hybrid type laser diode chips are packaged based on the substrate an alignment marking formed on a base of the substrate; the alignment technique also includes an active alignment method, in which two laser diode chips are aligned based on the laser emitting diode (LED) illumination generated by a laser diode chip.

An alignment technique is disclosed in Kokai No. H3-95506, in which two laser diode chips, installed on a substrate, are aligned with reference to another substrate. Another alignment technique is disclosed in Kokai No. H8-339570, in which a guide groove, readily formed on a substrate, is meant to be a reference point. When two laser diode chips are mounted on the guide groove, defining the space between the two laser diode chips is accurately defined.

A more stringent specification is required for alignment of laser diode chips in a light source device due to a market need for a thinner optical head apparatus. For example, the tolerance for deviation of the distance between illumination points of two laser diodes must be less than several microns. Since the accuracy of a typical mounting instrument of a hybrid type light source is about ±20 μm, it yields poor products when used in a passive alignment method. Also, typical advanced precision packaging instruments have poor mounting efficiency, affecting throughput.

When two laser diode chips are loaded in a guide groove which is formed on a substrate beforehand, it is possible to define the distance between two emitting points precisely, as disclosed in Kokai No. H8-339570. Nonetheless, the accuracy issue in aligning a light source in an optical head apparatus an object to be aligned in an optical axial direction remains, and requires a solution.

### OBJECT AND SUMMARY OF THE INVENTION

In consideration of the above mentioned issues, an object of the present invention is to provide a light source device in an optical head apparatus by which a laser diode chip can be aligned accurately to record/reproduce data on optical data on optical data storage media.

In accordance with the invention, a light source device for an optical head apparatus comprises at least one laser diode chip and a semiconductor substrate integral with the laser chip. The light source device is formed in a recess of the semiconductor substrate for aligning the laser diode chip on a surface of the semiconductor substrate by a semiconductor processing technique. The recess comprises a first side surface for defining a laser beam emitted from the laser diode chip in an optical axial direction and a second side surface for defining a direction perpendicular to the optical axial direction.

### BRIEF DESCRIPTION OF THE DRAWINGS

In the drawings:

FIG. 1(a) is a plan view which shows one embodiment of an optical head apparatus in which a light source device in accordance with the present invention is installed, and

FIG. 1(b) is a cross sectional view which shows the embodiment of the optical head apparatus;

FIG. 2(a) is a plan view which shows the light source device in FIG. 1, and

FIG. 2(b) is a perspective view which shows optical components attached to a part holder;

FIG. 3 describes a mechanism to position two laser diode chips in the light source device in FIG. 1;

FIG. 4 is a chart which shows assembly steps for manufacturing the light source device in FIG. 1;

FIG. 5(a) is a perspective view which shows an embodiment of the light source device in FIG. 1;

FIG. 5(b) is a perspective view which shows another embodiment of the light source device in FIG. 1;

FIG. 5(c) is a perspective view which further shows another embodiment of the light source device in FIG. 1;

FIG. 6 is a perspective view which shows another embodiment of the light source device in FIG. 1;

FIG. 7(a) shows another embodiment the light source device in FIG. 1;

FIG. 7(b) shows another embodiment of the light source device in FIG. 1;

FIG. 7(c) shows further another embodiment of the light source device in FIG. 1;

FIG. 8(A) is a perspective view which shows a mechanism to position first and second laser diode chips in the light source device of FIG. 1 and FIG. 8(B) is a plan view of the same;

FIG. 9 is a chart which shows processing steps for installing the first and second laser diode chips in a semiconductor substrate;

FIG. 10 is a perspective view which shows a submount wafer on which projections are formed;

FIG. 11 is a perspective view showing the distance between laser emitting points of the first and the second laser diode chips aligned in the light source device of FIG. 1;

FIG. 12(A) is a perspective view which shows another embodiment of the light source device in FIG. 1;

FIG. 12(B) is its plan view;

FIG. 13(A) is a perspective view which shows another alternate embodiment of the light source device in FIG. 1;

FIG. 13(B) is a plan view of the same;

FIG. 14(A) is a perspective view which shows an embodiment of the light source device in FIG. 1;

FIG. 14(B) is a plan view of the same; and

FIG. 14(C) shows another embodiment of the light source device in FIG. 1.

### DESCRIPTION OF THE PREFERRED EMBODIMENTS

With reference to the accompanying drawings, the preferred embodiment of an optical head apparatus having a light source device in accordance with the present invention is described in detail below.

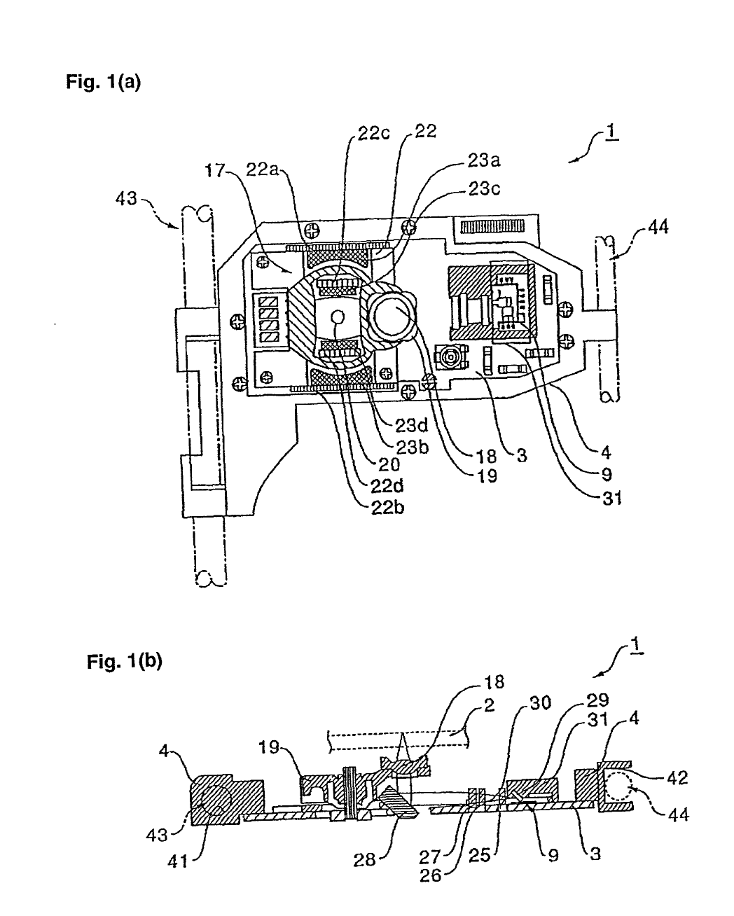

FIGS. 1(a) and 1(b) are a plan view and cross sectional view which show an embodiment of the optical head apparatus of the present invention.

An optical head apparatus 1 of the present invention is a dual wavelength optical head apparatus, capable of recording/reproducing data to/from an optical data storage medium 2 such as CD and DVD (laser beam wavelength=1350 nm and 780 nm, respectively), and has circuit board 3 made of metals (e.g. iron, aluminum), on which various components are installed. Circuit board 3 is supported by frame 4. A round main shaft guide hole 41 is formed on one end of frame 4, and a substantially U-shaped countershaft guide groove 42, open to the horizontal direction, is formed on the other end.

Main shaft 43 and countershaft 44 are extend in parallel toward the side on which a data recording/reproducing apparatus (not shown) having optical head apparatus 1 is installed, which allows main shaft 43 go through guide hole 41 and countershaft 44 go through guide groove 42 so that frame 4 covers (the area) between main shaft 43 and countershaft 44. Optical head apparatus 1 is, thus, capable of moving linear and rotary motion across optical data storage medium 2 along main shaft 43 and countershaft 44.

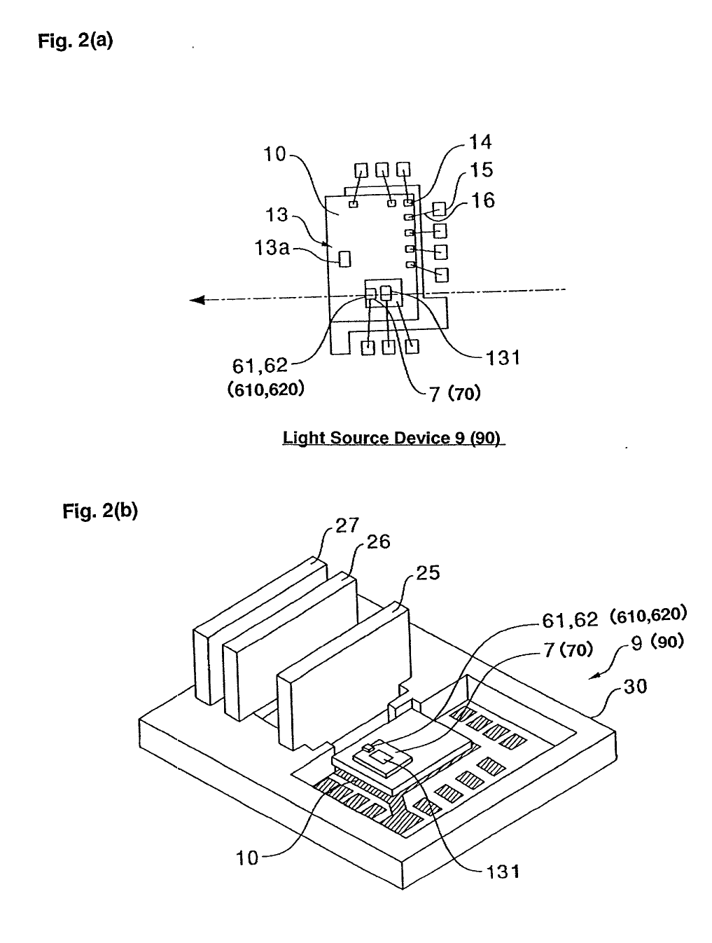

A light source device 9, in which laser diodes and light receiving elements are integrated into each other, as shown in FIG. 2(a), is installed on the surface of circuit board 3 toward the guide groove 42. Light source device 9 comprises:

a semiconductor substrate 10, bonded by a silver paste to the surface of circuit board 3;

a submount 7, bonded to the surface of semiconductor substrate 10; and

a first and a second laser diode chips 61 and 62, bonded to the upper surface of submount 7.

First laser diode chip 61 emits a laser beam with a wavelength of 650 nm, and second laser diode chip 62 emits a laser beam with a wavelength of 780 nm.

A photodiode integrated circuit (PDIC) and a light receiving element 13 having a light receiving surface 13a for reproducing signals are formed integral with semiconductor substrate 10. A light receiving monitoring element 131 is integrally formed with submount 7. Also, electrode terminal 14, formed on the side of light source device 9, and electrode terminal 15, formed on the surface of circuit board 3, are connected by bonding wire 16.

A magnetic object lens' driving mechanism 17 (FIG. 1) is mounted on the surface of circuit board 3 toward the guide hole 41. Magnetic object lens driving mechanism 17 comprises:

a lens holder 19 for holding object lens 18;

a shaft 20 for supporting lens holder 19 capable of motion in a tracking direction and in a focusing direction; and

a magnetic driving circuit for generating a magnetic force for moving lens holder 19 in a tracking direction and a focusing direction.

The magnetic driving circuit comprises:

magnets 23a, 23b, 23c and 23d attached to rising parts 22a, 22b, 22c and 22d, which are formed on bent yoke plate 22; and

a driving coil (not shown) disposed on the lens holder arranged opposite to the magnets.

The magnetic object lens driving mechanism of this type in which the lens holder slides and rotates on a shaft is well known.

In FIG. 1, first diffraction grating 25, second diffraction grating 26, collimating lens 27 and raised mirror 28 are disposed on the optical path from first and second laser diode chips 61 and 62 to object lens 18. First diffraction grating 25 provides a wavelength selectivity for a laser beam emitted from second laser diode chip 62, isolates the laser beam with a wavelength of 780 nm and splits the laser beam into three beams. Second diffraction grating 26 is a hologram element, which provides a wavelength selectivity for a laser beam returning from optical data storage medium 2, taking a different optical path via total reflection mirror 29, to light receiving surface 13a of light receiving element 13. The emitted light is collimated by collimating lens 27, generating collimated beams, and are reflected by raised mirror 28 orthogonally to reach object lens 18.

In the present embodiment, light source device 9, first and second diffraction gratings 25 and 26, and collimating lens 27 are mounted on circuit board 3, using part holder 30, which holds these parts together to ensure the alignment. As shown in FIG. 2(b), the overall part holder 30 is a substantially U-shaped photosensitive glass frame made of a flat plate. Inside of part holder 30 are formed recesses, projections, and windows, that are required for holding light source device 9, first and second diffraction gratings 25 and 26, and collimating lens 27 at predetermined positions and in predetermined orientations, respectively. Therefore, when light source device 9, first and second diffraction gratings 25 and 26, and collimating lens 27 are placed in part holder 30, the optical axes and positions of these parts in an optical axial direction are automatically adjusted.

Cover 31 is attached to a part of part holder 30 having light source device 9 installed, thereby sealing light source device 9 for protection. Total reflection mirror 29 is attached to the lower surface of cover 31.

In the optical head apparatus of the above construction, when data are reproduced onto optical data storage medium 2 (DVD), a laser beam with a wavelength of 650 nm is emitted from first laser diode chip 61. Also, when data are stored onto optical data storage medium 2 (CD-R), a laser beam with a wavelength of 780 nm is emitted from second laser diode chip 62. Data are, thus, reproduced/stored in different kinds of optical data storage medium 2.

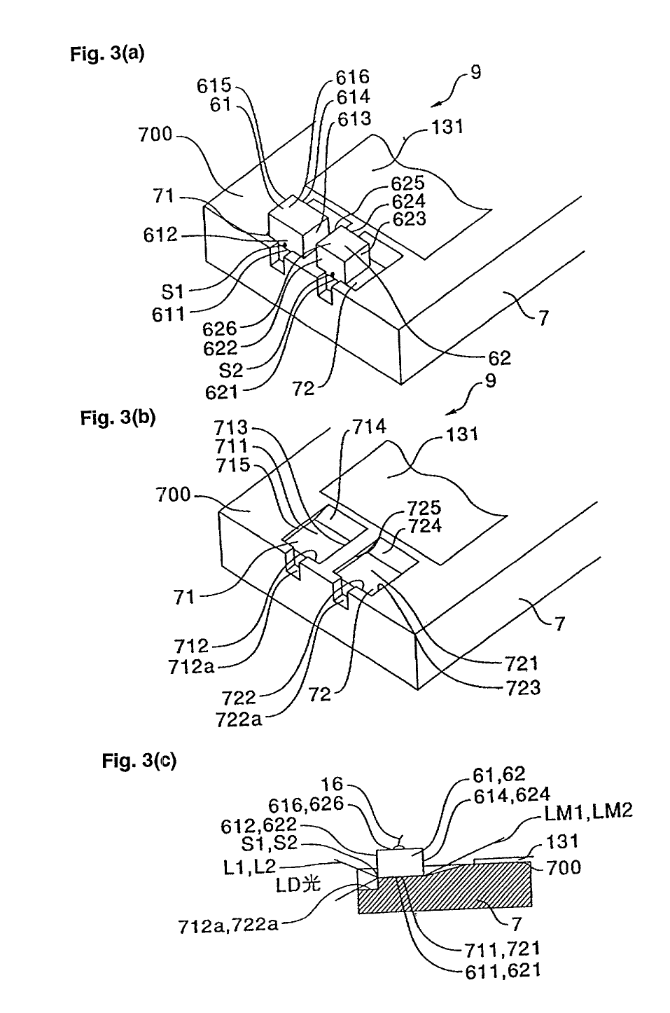

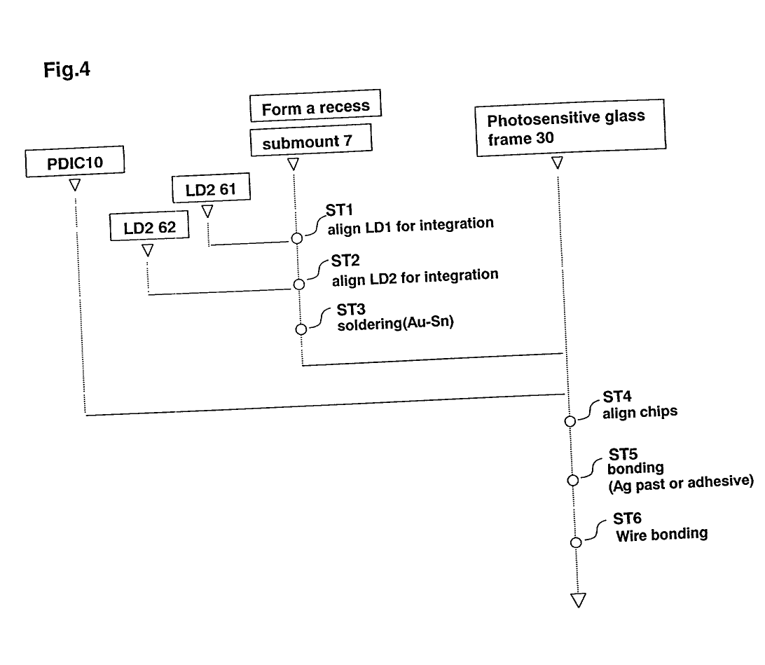

FIG. 3 shows a mechanism for aligning first and second laser diode chips 61 and 62 in light source device 9 in accordance with the present embodiment. FIG. 4 shows an assembly step for light source device 9.

As shown in FIG. 3, first laser diode chip 61, having a parallelepiped shape, comprises:

a front emitting surface 612, having a first front emitting point S1 for emitting a first laser beam L1;

back emitting surface 614, having a back emitting point, right side and left side surfaces 613 and 615;

an upper surface 616, having an N-electrode (negative electrode); and

a lower surface 611 having a P-electrode (positive electrode).

First laser diode chip 61 is of the “P-side down” type, in which first front emitting point S1 is located at front emitting surface 612 pointing toward P-electrode. Lower surface 611 is mounted on submount 7, so that heat, generated from first front emitting point S1, is efficiently released. A first monitoring laser beam LM1 is emitted from back emitting surface 614.

Second laser diode chip 62 has a shape identical to that of first laser diode chip 61, and comprises:

a front emitting surface 622, having second front emitting point S2 which emits second laser beam L2;

a back emitting surface 624 having a back emitting point;

right and left side surfaces 623 and 625;

an upper surface 626 having an N-electrode; and

a lower surface 621 having a P-electrode.

Second laser diode chip 62 also is of the “P-side down” type, in which second front emitting point S2 is located at front emitting surface 622 pointing toward P-electrode. Lower surface 621 is mounted on submount 7, so that heat generated from second front emitting point S2 is efficiently released. A second monitoring laser beam LM2 is emitted from back emitting surface 624.

On upper surface 700 of submount 7, first alignment recess 71, for aligning first laser diode chip 61, and second alignment recess 72, for aligning second laser diode chip 62, are cut out side by side. A light receiving monitoring element 131 is mounted behind first and second recesses 71 and 72.

First recess 71, having a rectangular shape larger than lower surface 611 of first laser diode chip 61, comprises:

a bottom surface 711;

a front surface 712;

right and left side surfaces 713 and 715, standing perpendicularly from the three sides of bottom surface 711, and an inclined end surface 714 inclined backward.

Second recess 72, also having an identical rectangular shape to that of first recess 71 and larger than lower surface 621 of second laser diode chip 62, comprises: a bottom surface 721; a front surface 722; right and left side surfaces of 723 and 725, standing perpendicularly from the three sides of bottom surface 721; and an inclined end surface 724 inclined backward.

Also, recesses 712a and 722a for passing first and second laser beams extend in directions in which first and second laser beams L1 and L2 are emitted, and are formed continuously from front surfaces 712 and 722 on alignment recesses 71 and 72, respectively.

The two laser diode chips 61 and 62, placed on first and second alignment recesses 71 and 72, are pushed against front surfaces 712 and 722, and side surfaces 713 and 725, respectively to secure the chips thereon. Front surfaces 712 and 722, thus, define the optical axial direction of laser beams L1 and L2 emitted from first and second laser diode chips 61 and 62, respectively. Side surfaces 713 and 725 defines the direction perpendicular to the optical axial direction. As a result, the distance between the first and second front emitting points S1 and S2 is defined by the distance between side surfaces 713 and 725.

Recesses 712a and 722a for passing first and second laser beams are continuous with front surfaces 712 and 722 of alignment recesses 71 and 72 respectively, resulting in preventing laser beams L1 and L2, emitted at a predetermined divergence angle, from being interrupted.

Back end of alignment recesses 71 and 72 are defined by back surfaces 714 and 724 respectively. Therefore, first and second monitoring laser beams LM1 and LM2, emitted from back emitting surfaces 614 and 624, are led to light receiving monitoring element 131 without being shielded by the end recesses 71 and 72.

Steps of assembling light source device 9 is described herein with reference to FIG. 4. First, submount 7, having first and second alignment recesses 71 and 72 and passage recesses 712a and 722a for passing first and second laser beams, is formed. First and second alignment recesses 71 and 72 are given a depth of 1 μm to 50 μm by a semiconductor processing (photolithography) technique. Bottom surfaces 711 and 721 supply power to the P-electrode at lower surfaces 611 and 621 of first and second laser diode chips 61 and 62, respectively. AuSn film as a solder is formed on bottom surfaces 711 and 721. Also, passage recesses 712a and 722a for passing first and second laser beams are formed by a semiconductor processing (photolithography) technique as well.

The “STn” notations used hereafter (where n=1, 2, 3, etc.), are processing step numbers for assembling light source device 9. In steps STI and ST2, first laser diode chip (LD1) 61 and second laser diode chip (LD2) 62 are placed on first and second alignment recesses 71 and 72 on submount 7. At this time, as shown in FIG. 3(a), first laser diode chip (LD1) 61 and second laser diode chip (LD2) 62 are fitted into first and second alignment recesses 71 and 72, such that front emitting surfaces 612 and 622 are pushed against front surfaces 712 and 722; surfaces 613 and 625 that are on the plane perpendicular to front emitting surfaces 612 and 622, are pushed against side surfaces 713 and 725, respectively.

Next, in step ST3, first laser diode chip (LD1) 61 and second laser diode chip (LD2) 62 are fixed onto submount 7 by curing the AuSn film by baking.

In steps ST4 and ST5, submount 7 and semiconductor substrate 10, having a light receiving element for signal reproduction and a photodiode integrated circuit (PDIC) for signal processing, are stacked, and aligned together on the surface of part holder (photosensitive glass frame) 30 attached on circuit board 3, followed by bonding utilizing Ag paste, or the like.

In step ST6, N-electrodes on upper surfaces 616 and 626 of first and second laser diode chips 61 and 62, electrodes on submount 7 and sides of semiconductor substrate 10, and electrode terminals arranged on sides of circuit board 3, are wire bonded to provide light source device 9 as shown in FIG. 2.

As described above, in light source device 9 of an optical head apparatus in accordance with the present invention, first and second alignment recesses 71 and 72 for aligning first and second laser diode chips 61 and 62 are formed on upper surface 700 of submount 7 by a semiconductor processing technique. First and second recesses 71 and 72 includes front surfaces 712 and 722, for defining laser beams L1 and L2 emitted from first and second laser diode chips 61 and 62 in the optical axial direction; and side surfaces 713 and 725, for defining the laser beams in the direction perpendicular to the optical axial direction. First and second laser diode chips 61 and 62, mounted on submount 7, thus define a laser beam both in the optical axial direction and in a direction perpendicular to the optical axial direction, thereby aligning the space between each of the illumination points accurately. For this reason, this invention does not require advanced precision packaging equipment in order to align laser diode chips 61 and 62 with submount 7 during assembly.

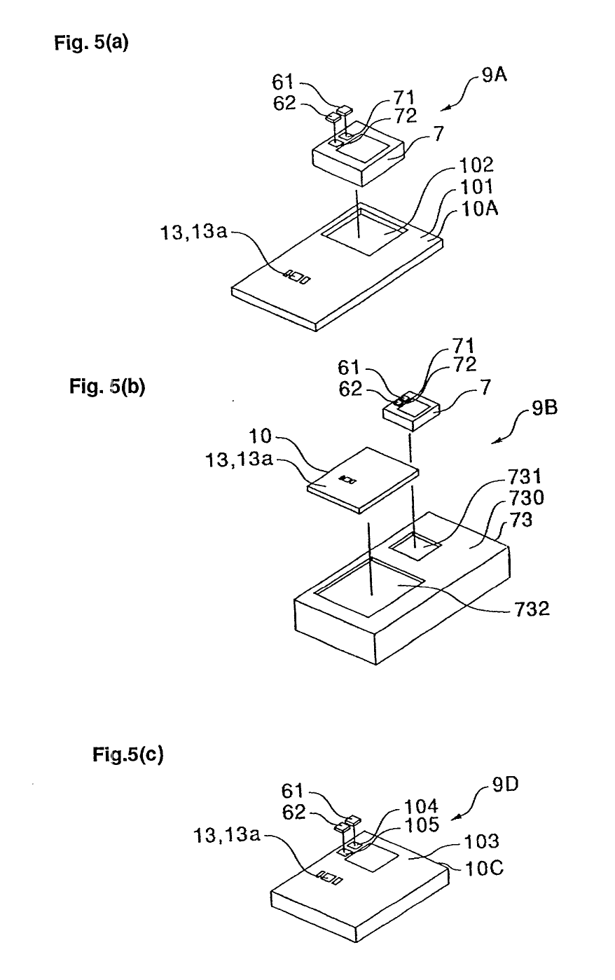

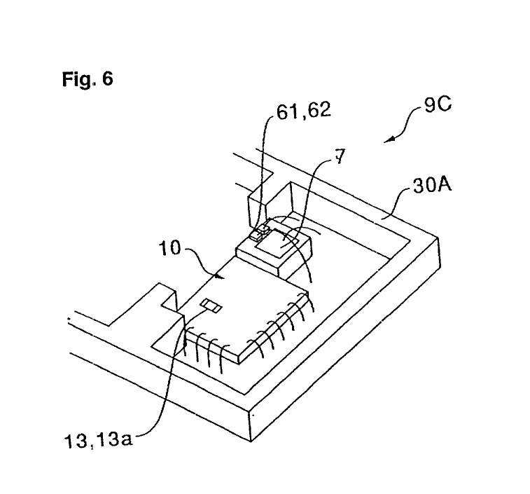

FIGS. 5(a), 5(b) and 5(c) and FIG. 6 are perspective views of alternate embodiments of a light source device.

An exemplary light source device 9A shown in FIG. 5(a), submount 7, on which first and second laser diode chips 61 and 62 are mounted, is stacked on semiconductor substrate 10A being made integral with light receiving element 13.

On surface 101 of IC chip 10A, recess 102 for aligning submount 7 is formed by the semiconductor process technique. Therefore, submount 7 can be aligned simply by mounting submount 7 on semiconductor substrate 10A. Also, two laser diode chips 61 and 62 are aligned on submount 7 with good precision. The overall alignment accuracy for laser diode chips 61 and 62 and light receiving element 13 are thus ensured.

In exemplary light source devices 9 and 9A described above, submount 7, having first and second laser diode chips 61 and 62, is stacked on semiconductor substrates 10 and 10A. However, submount 7, and semiconductor substrates 10 and 10A can be disposed in parallel.

For example, in light source device 9B shown in FIG. 5(b), submount 7, having first and second laser diode chips 61 and 62, and semiconductor substrate 10 having light receiving element 13 formed integral therewith, are mounted on surface 730 of semiconductor block 73 in parallel.

On surface 730 of semiconductor block 73, recess 731 for aligning submount 7 and recess 732 for aligning semiconductor substrate 10 are formed by a semiconductor processing technique. Submount 7 and semiconductor substrate 10 can be thus aligned by simply mounting submount 7 and semiconductor substrate 10 on semiconductor block 73. This is a simple process yet is capable of providing precise alignment of laser diode chips 61 and 62 and light receiving element 13.

Submount 7, having laser diode chips 61 and 62, and semiconductor substrate 10 may be aligned on part holder 30A, and arranged in parallel as shown in FIG. 6. In light source device 9C, part holder 30A is a substantially U-shaped photosensitive glass frame made by cutting out a flat plate, and has surfaces for aligning semiconductor substrate 10 and submount 7 therein. Submount 7 and semiconductor substrates 10 are, thus, aligned by only mounting submount 7 and semiconductor substrate 10 on part holder 30A.

As described above, in light source devices 9A, 9B and 9C, alignment of submount 7 and semiconductor substrates 10A, 10 initiates subsequent alignment of first and second laser diode chips 61 and 62, mounted on submount 7, and light receiving surface 13a of light receiving element 13, formed integral with semiconductor substrate 10 and 10A.

First and second laser diode chips 61 and 62 may also be installed directly on semiconductor substrate 10 instead of installing in submount 7.

As shown in FIG. 5(c), in light source device 9D, first and second laser diode chips 61 and 62 are stacked on semiconductor substrate 10C, with which light receiving element 13 is integrally formed.

On surface 103 of semiconductor substrate 10C, recesses 104 and 105 for aligning first and second laser diode chips 61 and 62 are formed by the semiconductor processing technique. Therefore, alignment of first and second laser diode chips 61 and 62 can be initiated simply by mounting laser diode chips 61 and 62 on semiconductor substrate 10C, thereby aligning first and second laser diode chips 61 and 62 and light receiving surface 13a of light receiving element 13 mounted on semiconductor substrate 10C.

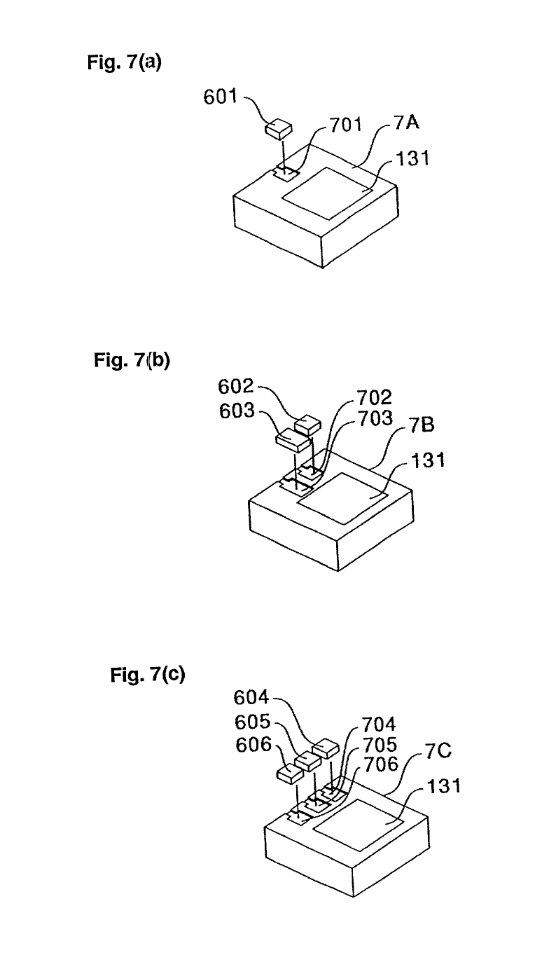

The present invention can be applied to a light source device having a single laser diode chip. FIG. 7(a) shows one of the examples of a light source device having only one laser diode chip 601. If the laser diode chip, which emits a laser beam of single wavelength, or is of the monolithic type, which emits laser beams of different wavelengths, formation of one recess 701 on submount 7A is enough for aligning laser diode chip 601.

The present invention can be applied to a light source device having different laser diode chips of different sizes. As shown in FIG. 7(b), for example, when laser diode chip 603 is more powerful and larger than laser diode chip 602, two recesses 702 and 703 for aligning a light source will need to be formed on submount 7B. As for size of the recess, recess 703 will need to be larger than recess 702 but as large as diode chip 603.

The present invention can be applied to a light source device having more than three laser diode chips. FIG. 7(c) shows an example of the type in which a light source device has three laser diode chips 604, 605 and 606 of different wavelengths. In this case, three recesses 704, 705 and 706 will need to be formed on submount 7C for aligning a light source device.

In submounts 7A, 7B and 7C, laser diode chips 601-606 of any shape, type, and number can be aligned by forming recesses 701-706 on submounts 7A, 7B, and 7C in the shape of the laser diode chip of one's choice.

With reference to the drawings, another preferred embodiment of an optical head apparatus in which a light source device in accordance with the present invention is installed is described.

For an optical head apparatus, see FIGS. 1(a) and 1(b) described above, which are a plan view and cross sectional view of an optical head apparatus in accordance with the present embodiment. FIGS. 2(a) and 2(b) are a plan view and a perspective view of a light source device shown in FIG. 1, respectively.

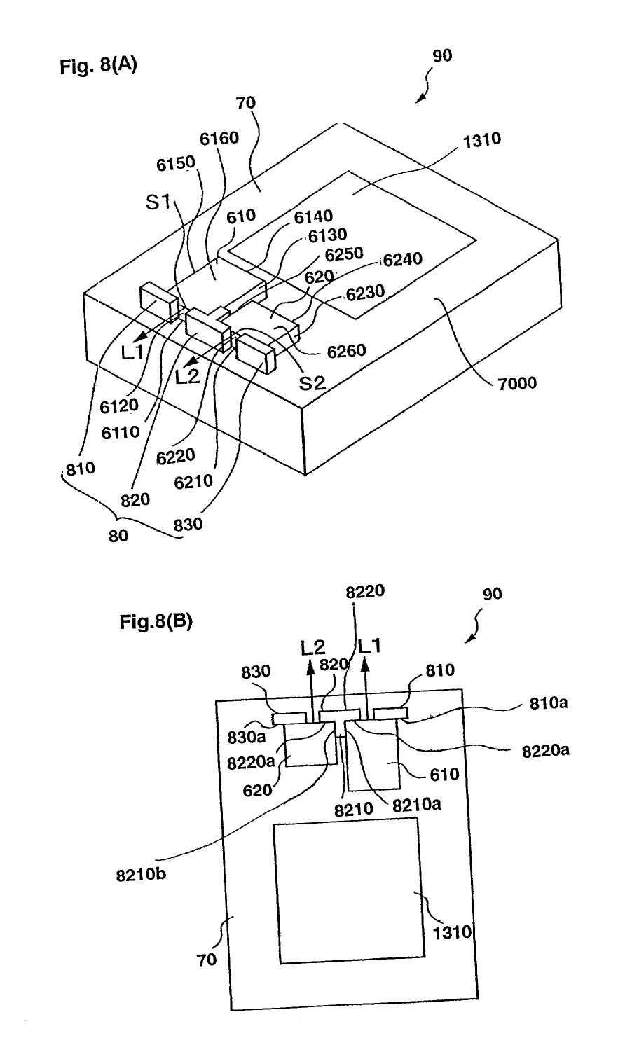

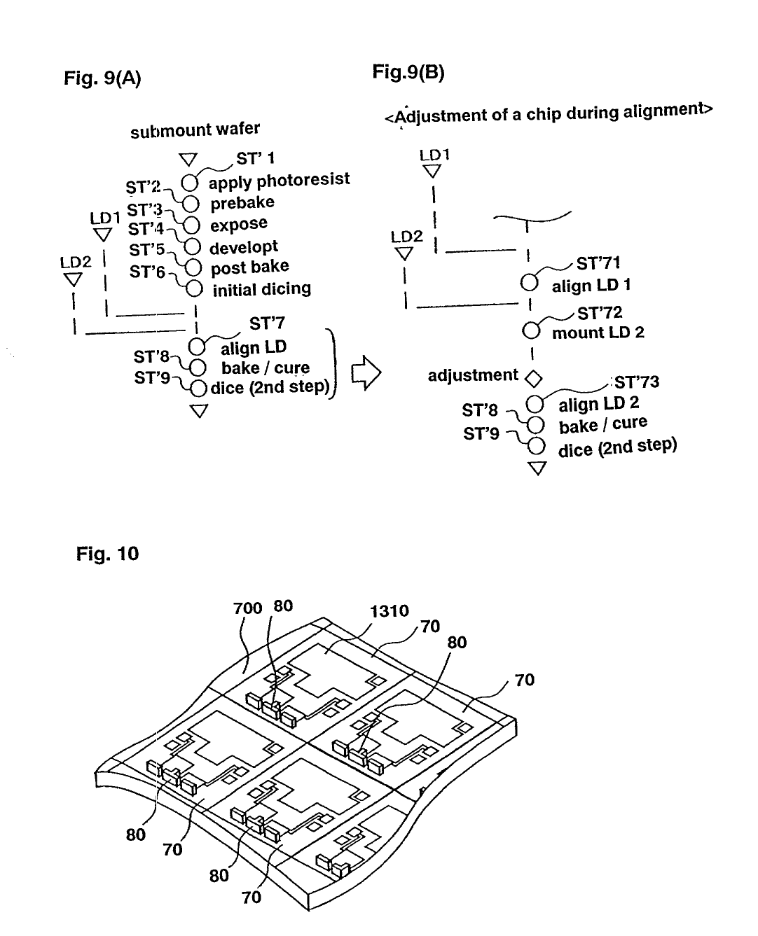

FIG. 8 is a diagram showing a mechanism for aligning two laser diode chips 610 and 620 in light source device 90 in accordance with the present invention. FIG. 9 shows a mounting step for laser diode chips 610 and 620. FIG. 10 is; a perspective view to show a submount wafer in which projections for alignment of IC chips are formed.

As shown in FIG. 8(A), first laser diode chip 610, having approximately a parallelepiped shape comprises:

a front emitting surface 6120, having a first front emitting point S1 emitting first laser beam L1;

a back emitting surface 6140 having a back emitting point S2;

right and left side surfaces 6130 and 6150;

an upper surface 6160 having a P-electrode; and

a lower surface 6110 having an N-electrode.

First laser diode chip 610, arranged in such a way that first illumination point S1 on emitting surface 6120 is located at the intersection of the upper surface 6160 of P-electrode, is fixed thereon in the “P-side up” configuration, in which the P-electrode side is pointing upward. A monitoring laser beam is emitted from back emitting surface 6140 backward.

Second laser diode chip 620 has a shape of approximately parallelepiped smaller than first laser diode chip 610, and comprises:

a front emitting surface 6220, having a second front emitting point S2 emitting second laser beam L2;

a back emitting surface 6240 having back emitting point;

right and left side surfaces 6230 and 6250;

an upper surface 6260, having a P-electrode; and

a lower surface 6210 having an N-electrode.

Second laser diode chip 620 is also of the “P-side up” type, in which second front illumination point S2 is located on emitting surface 6220 at the (intersection of the) upper surface 6260 side of the P-electrode, and fixed thereon such that P-electrode points upward. A monitoring laser beam is emitted from back emitting surface 6240 backward.

On upper surface 7000 of submount 70, first projection 810 in a parallelepiped shape, is coated with a photoresist material, second projection 820 in a T-shape and third projection 830 in a parallelepiped shape stand perpendicular to the upper surface of submount 70. These projections constitute projection 80 for aligning the first and second laser diode chips 610 and 620. A light receiving monitoring element 1310 is formed integral with upper surface 7000 of submount 70 on the back end of first and second laser diode chips 610 and 620.

Projection 80 for aligning is described in detail with reference to FIG. 8(B). Second projection 820, in the middle of alignment projection 80, includes horizontal wall 8220, extending in a right and left directions, and partition wall 8210 extending perpendicularly from the mid point of the back surface 8220a of horizontal wall 8220 backward. First projection 810 is disposed on one end of second projection 820 at a predetermined interval; back surface 810a of first projection 810 is leveled with back surface 8220a of second projection 820. Similarly, third projection 830 is disposed on the other end of second projection 820 at a predetermined interval; back surface 830a of third projection 830 is leveled with back surface 8220a of second projection 820.

Right and left side surfaces 8210a and 8210b of partition wall 8210 of second projection 820, being perpendicular to the surface of the submount and being parallel to each other, define the positions of first and second laser diode chips 610 and 620 in the direction perpendicular to the optical axial direction. Also, end surfaces 810a, 8220a and 830a of projections 810, 820 and 830, respectively, prescribe the positions of laser diode chips in the optical axial direction.

Next, mounting steps for first and second laser diode chips 610 and 620 are described with reference to FIG. 9(A). First, a plurality of submounts 70 are formed integral with a submount wafer patterned in a lattice structure. A light receiving monitoring element 1310 is also formed integral with each submount 70.

The “ST′n” notation (where n=1,2,3, etc.) are processing step numbers. In step ST′ 1, a resist material is applied to a part of submount 70 in which alignment projection 80 is formed. The photoresist material may be a liquid or film type. In step ST′ 2, the resist material is prebaked. Then, the photoresist material is exposed and developed in steps ST′ 3 and ST′ 4, followed by a postbaking in step ST′ 5. As a result, as shown in FIG. 10, submount wafer 700, on which alignment projection 80 having first projection 810, second projection 820, and third projection 830, formed on each submount 70, can be obtained. Alignment projection 80 is given a precision as good as that of a photomask determined during a photomask's exposure to light, and a photomask thickness of several μm to 300 μm.

In step ST′ 6, a first dicing is carried out to submount wafer 700 so that submount wafer 700 has a size suitable for the next processing step. In step ST′ 7, first laser diode chip (LD1) 610 and second laser diode chip (LD2) 620, being mounted at the positions defined by projection 80, are each aligned with submount 70.

In step ST′ 8, first laser diode chip (LD1) 610 and second laser diode chip (LD2) 620 are soldered to submount 70 by a AuSn film applied to either first laser diode chip (LD1) 610 and second laser diode chip (LD2) 620 or submount 70 by baking for curing.

In step ST′ 9, during the second dicing step, submount wafer 700 is diced to produce submount 70 of a predetermined size.

A3 described above, in light source device 90 of an optical head apparatus in accordance with the present invention, projection 80, for aligning first and second laser diode chips 610 and 620, is formed on upper surface 7000 of submount 70 by a photolithography technique using a photomask comprising a photosensitive resin. This alignment projection 80 comprises: end surfaces 810a, 8220a, and 830a of first projection 810, a second projection 820, and a third projection 830, respectively, which define laser beams L1 and L2 emitted from the first and second laser diode chips 610 and 620 in an optical axial direction; right and left side surfaces 8210a and 8210b of partition wall 8210 of second projection 820, for defining the laser beams in a direction perpendicular to an optical axial direction. Therefore, when first and second laser diode chips 610 and 620 are mounted in submount 70, their positions in an optical axial direction, their positions in a direction perpendicular to an optical axial direction, and the distance between their emitting points can be determined with good precision. In all respects, this invention does not require advanced precision packaging equipment for aligning laser diode chips 610 and 620 with submount 70 during assembly.

In step ST′ 7 as shown in FIG. 9(A), projection 80 was used for defining two laser diode chips, that are subsequently fixed thereon. In step ST′ 71, as shown in FIG. 9(B), first laser diode chip 610 is aligned with projection 80, then, in step ST′ 72, second laser diode chip 620 is mounted on submount 70, thereby adjusting the second laser diode chip 620 in step ST′ 73.

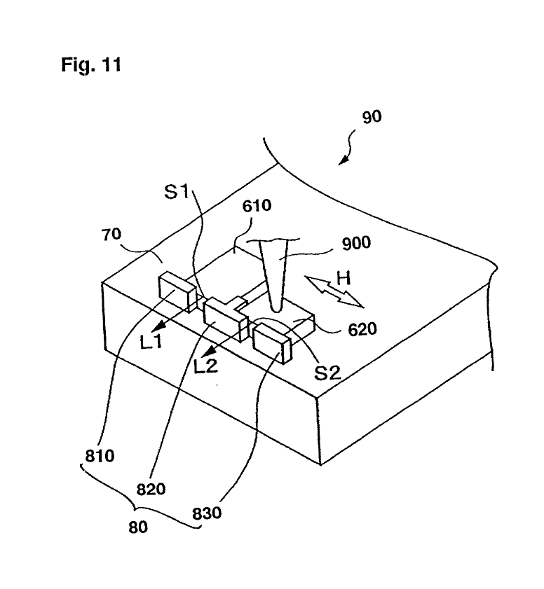

In other words, in step ST′ 72, second laser diode chip 620 is held by suction probe (vacuum chuck) 900, on submount 70 having first laser diode chip 610 being aligned with reference to alignment projection 80, as shown in FIG. 11. In this condition, the position of second laser diode chip 620 is adjusted either with reference to an alignment mark or laser emitting diode (LED) illuminating first and second laser diode chips 610 and 620 simultaneously while monitoring the positions of the two laser diode chips on a screen. Second laser diode chip 620, being held by suction probe (vacuum chuck) 900, is adjusted by moving, in the direction marked with an arrow “H,” along the reference surface, is defined by projection 80's back surfaces 8220aand 830a of second projection 820 and third projection 830. Therefore, the distance between emitting points of first and second laser diode chips 610 and 620 can be adjusted by moving the second laser diode 620 in one direction only, which is a simple procedure.

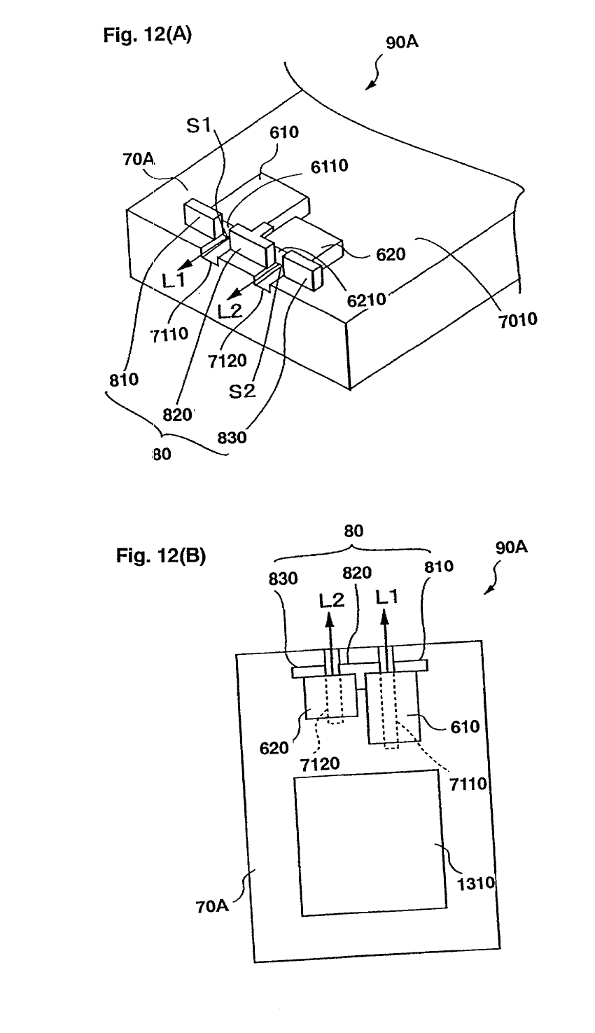

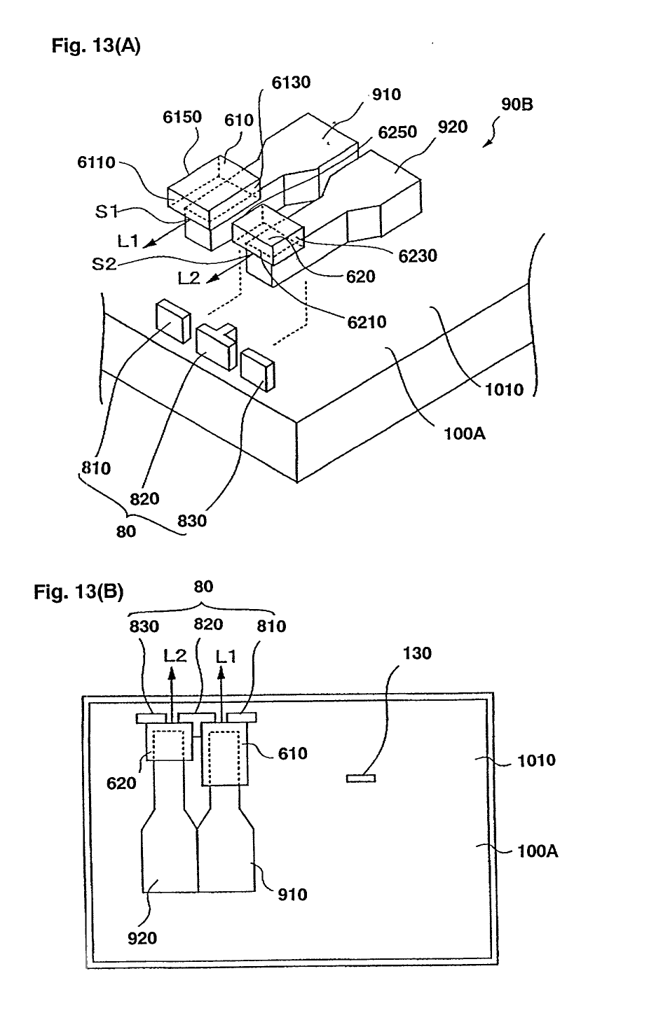

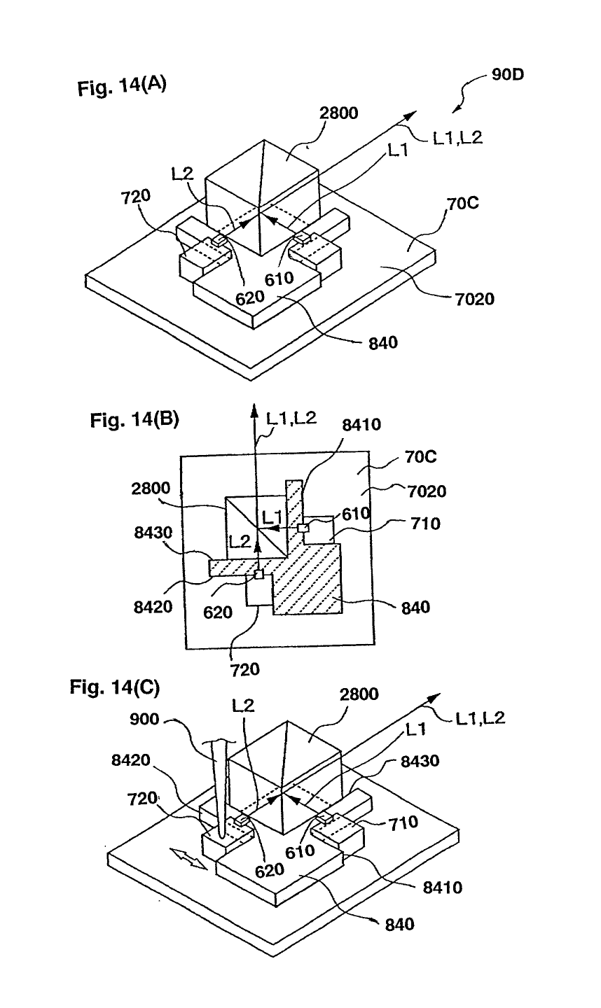

FIG. 12, FIG. 13 and FIG. 14 are perspective views of alternate embodiments of a light source device.

In the above mentioned embodiment, first and second laser diode chips 610 and 620 are fixed such that P-electrode points upward, in other words, in the “P-side up” position. First and second laser diode chips 610 and 620 may be fixed upside down, in other words, in the “P-side down” position, in which the P-electrode points toward submount 70, which may release heat generated from an emitting point side more efficiently.

As shown in FIGS. 12(A) and 12(B), in light source device 90A, first and second laser diode chips 610 and 620 are fixed in the “P-side down” position, as a result, first and second front illumination points S1 and S2 are placed toward submount 70A.

On surface 7010 of submount 70A, first projection 810, second projection 820 and third projection 830 constituting projection 80 for aligning first and second laser diode chips 610 and 620 are formed. Recesses 7110 and 7120 for passing a laser beam are formed by carving from the positions of end surfaces 810a, 8220a and 830a by etching or dicing.

Light source device 90A made by the steps as described above has recesses 7110 and 7120 for passing first and second laser beams, as a result, laser beams L1 and L2, emitted at a predetermined angle from first and second laser diode chips 610 and 620, being fixed in the “P-side down” position will not be interrupted by surface 7010 of submount 70A. Also, first and second laser diode chips 610 and 620 can be aligned with reference to alignment projection 80.

Instead of forming recesses 7110 and 7120 for passing laser beams on the surface of semiconductor substrate 100A, first and second laser diode chips 610 and 620 may be fixed in the “P-side down” position, using a spacer member. Also, instead of installing laser diode chips 610 and 620 on submount 70A, laser diode chips 610 and 620 may be installed directly on semiconductor substrate 100A with which light receiving element 130 and a PDIC are integrally formed.

As shown in FIGS. 13(A) and 13(B), in light source device 90B having light receiving element 130 made integral with semiconductor substrate 100A, first and second laser diode chips 610 and 620 are fixed in the “P-side down” position, and first and second front illumination points S1 and S2 are placed toward semiconductor substrate 100A.

On surface 1010 of semiconductor substrate 100A are formed projection 80 for aligning first and second laser diode chips 610 and 620. First and second laser diode chips 610 and 620 are mounted on projection 80 using spacer materials 910 and 920 made of a metallic or semiconductor material, respectively. The widths of spacer materials 910 and 920 are smaller than those of first and second laser diode chips 610 and 620, respectively. Spacer materials 910 and 920 are arranged inside of front illumination surfaces 6110 and 6210, and side surfaces 6130, 6150, 6230 and 6250. First and second laser diode chips 610 and 620, being aligned by projection 80, stands out from surface 1010 of semiconductor substrate 100A due to spacer materials 910 and 920. For this reason, a laser beam emitted at a predetermined angle will not be interrupted by the surface of semiconductor substrate 100A.

Also, light receiving element 130 is formed on surface 1010 of semiconductor substrate 100A. Light receiving element 130 can be aligned together with first and second laser diode chips 610 and 620, by initially aligning first and second laser diode chips 610 and 620 with reference to alignment projection 80.

The aligning mechanism of the present invention can be also applied to, for example, a light source device of an optical system, in which a first laser beam and a second laser beam are led to a common optical path, using a polarizing beam splitter made of composite materials as disclosed in Kokai No. HIO-149559.

In this case, as shown in FIG. 14(A), components on the surface 7020 of semiconductor substrate 70C in light source device 90D comprise: a first submount 710 formed with a first laser diode chip 610; second submount 720 formed with a second laser diode chip 620; polarizing beam splitter 2800 of a composite material, for leading first and second laser beams to a common optical path by reflecting first laser beam L1 and transmitting second laser beam L2; and an alignment projection 840.

As shown in FIG. 14(B), alignment projection 840, formed on surface 7020 of semiconductor substrate 70C, comprise: a first unit 8410 for aligning the L-shaped first submount 710; a second unit 8420 for aligning second submount 720, and a third unit 8430 for aligning polarized beam splitter 2800. The installation of first and second submounts 710 and 720 and polarized beam splitter 2800 on semiconductor substrate 70C aligns first and second laser diode chips 610 and 620 and polarized beam splitter 2800.

Also, as shown in FIG. 14(C), after polarizing beam splitter 2800 and first submount 710 are aligned, second submount 720, being held by suction probe (vacuum chuck) 900, may be aligned by pushing second submount 720 against the reference surface, pointing to the same direction as the emitting surface, provided by second alignment unit 8420 of projection 840, while moving second submount 720 in a given linear direction.

The above example relates to a light source device of an optical head apparatus for recording/reproducing CD, DVD data and the like. Needless to say the present invention is applicable to other optical instruments such as a light source device for optical communication modules requiring alignment of a laser diode chip and an optical fiber with a stringent specification.

As described above, in a light source device of an optical head apparatus in accordance with the present invention, first and second recesses for aligning first and second laser diode chips are formed on upper surface 700 of submount 7 by a semiconductor processing technique. First and second recesses comprised: front surfaces, for defining laser beams, emitted from first and second laser diode chips in the optical axial direction; and side surfaces for defining the laser beams in a direction perpendicular to the optical axial direction. First and second laser diode chips, mounted on submount, thus defines a laser beam both in the optical axial direction and in the direction perpendicular to the optical axial direction, thereby aligning the space between each of the illumination points accurately. For this reason, this invention does not require advanced precision packaging equipment in order to align laser diode chips with submount highly accurately during assembly.

The recess for aligning is formed by the semiconductor processing technique, thereby providing a excellent precision thereof. This makes it possible to create a recess of any depth and any shape, thereby providing a wide range of selection for arrangement of laser diode and submounts.

Also, in the present invention, the width and depth of a laser beam passage recess, formed on the front end of the alignment recess, correspond to the divergence angle of a laser beam. Therefore, the emitted laser beam will not be interrupted by the front end of the alignment recess.

In addition, in the present invention, the back surface of the recess is inclined. As a result, the monitoring laser beam emitted from the laser diode chip backward, can be led to a monitoring light receiving element for monitoring without being interrupted by the alignment recess.

Also, in a light source device according to the present Invention, a projection for aligning a laser diode chip is formed on the surface of a semiconductor substrate. A typical alignment projection comprises: side surfaces for defining a laser beam emitted from the laser diode chip in a optical axial direction; and side surfaces for defining the laser beam in a direction perpendicular to the optical axial direction.

For this reason, pushing the laser diode chip against an alignment projection defines the laser beam in an optical axial direction and in a direction perpendicular to the optical axial direction with high accuracy. As a result, the distance between illumination points of a plurality of laser diode chips can be aligned accurately.

In conclusion, the present invention provides a method for efficient alignment of laser diode chips without using advanced precision packaging equipment.

While the foregoing description and drawings represent the present invention, it will be obvious to those skilled in the art that various changes may be made therein without departing from the true spirit and scope of the present invention.

What is claimed is:

1. A light source device for an optical head apparatus, comprising:
at least one laser diode chip and a semiconductor substrate integral with said laser diode chip;
wherein said light source device is formed in a recess of said semiconductor substrate for aligning said laser diode chip on a surface of said semiconductor substrate by a semiconductor processing technique;
said recess comprising a first side surface for defining a laser beam emitted from said laser diode chip in an optical axial direction and a second side surface for defining a direction perpendicular to said optical axial direction.

2. The light source device for an optical head apparatus according to claim 1 wherein said first side surface and said second side surface are perpendicular to the surface of said semiconductor substrate.

3. The light source device for an optical head apparatus according to claim 1 wherein said semiconductor substrate is a light receiving element semiconductor substrate, formed integral with said semiconductor substrate so as to receive a returning laser beam from an optical data storage medium.

4. The light source device for an optical head apparatus according to claim 1 wherein said semiconductor substrate further comprises:
a light receiving monitoring element for receiving a laser beam emitted from a back end of said laser diode chip;
said light receiving monitoring element being integrally formed with said semiconductor substrate, thereby providing a heat releasing semiconductor substrate.

5. The light source device for an optical head apparatus according to claim 4, wherein said semiconductor substrate comprises said heat releasing semiconductor substrate and a light receiving element for receiving a laser beam returning from an optical data recording medium;
said light receiving element being integrally formed with said semiconductor substrate to provide a light receiving semiconductor substrate;
said alignment recess for aligning said heat releasing semiconductor substrate being integrally formed on a surface of said light receiving element semiconductor substrate by a semiconductor processing.

6. The light source device for an optical head apparatus as claimed in claim 4 wherein said semiconductor substrate comprises:
a light receiving element semiconductor substrate integrally formed with a light receiving element for receiving a laser beam returning from an optical data storage medium; and
a photosensitive glass frame;
an alignment surface for aligning said heat releasing semiconductor substrate and said light receiving element semiconductor substrate being on said photosensitive glass frame.

7. The light source device of an optical head apparatus as claimed in claim 1 wherein a recess for passage of a laser beam is formed on a surface of said semiconductor substrate by a semiconductor process;
said recess for laser beam passage of said laser diode chip extends from a front surface of said alignment recess toward the direction in which a laser beam is emitted, and
said front surface of said alignment recess opposing plane on which a front emitting point of said laser diode chip is included.

8. The light source device of an optical head apparatus as claimed in claim 1 wherein an end surface of said alignment recess is inclined backward;
said end surface of said alignment recess opposing a plane on which back emitting point of said laser diode chip is included;
and a light receiving monitoring element being formed integrally with said semiconductor substrate behind said end surface.

9. The light source device for an optical head apparatus according to claim 1 wherein said laser diode chip is a monolithic laser diode chip;
said monolithic laser diode chip emitting a laser beam of different wavelengths.

10. The light source device for an optical head apparatus according to claim 1 comprising a first laser diode chip and a second laser diode chip;
wherein said recess further comprises:
a first alignment recess and a second alignment recesses for defining said first laser diode chip; and
said second laser diode chip;
said first laser diode chip being defined by a first side surface and a second side surface, and is mounted into said first alignment recess;
and said second laser diode chip being slidingly mounted into said second alignment recess.

11. A light source device for an optical head apparatus, comprising:
at least one laser diode chip and a semiconductor substrate integral with said laser diode chip;
said semiconductor substrate having an alignment projection for aligning said laser diode chip on the surface of said semiconductor substrate.

12. The light source device for an optical head apparatus according to claim 11 wherein said alignment projection further comprises a coating made of photosensitive resin on a surface of said semiconductor substrate.

13. The light source device for an optical head apparatus according to claim 11 wherein said alignment projection further comprises:
a first side surface; and
a second side surface;
said first side surface defining a laser beam emitted from said laser diode chip in an optical axial direction, and said second side surface defining a laser beam in a direction perpendicular to said optical axial direction;
wherein said laser diode chip is aligned by pushing an emitting surface of said laser diode chip against said first side surface, and pushing another surface of said laser diode chip perpendicular to said emitting surface against said second side surface.

14. The light source device for an optical head apparatus according to claim 13 wherein said laser diode chip further comprises:
a first laser diode chip; and a second laser diode chip; and said alignment projection further comprises:
a first alignment projection for alignment of said first laser diode chip; and
a second alignment projection for aligning of said second laser diode chips.

15. The light source device for an optical head apparatus according to claim 11 wherein a recess for passage of a laser beam being formed on a surface of said semiconductor substrate;
said recess extending from said first side surface of said alignment projection in the direction of said laser beam.

16. The light source device for an optical head apparatus according to claim 11 wherein said laser diode chip is mounted on a surface of said semiconductor substrate utilizing a spacer member.

17. The light source device for an optical head apparatus according to claim 11 wherein said semiconductor substrate comprises a first semiconductor substrate and a second semiconductor substrate stacked on a surface of said first semiconductor substrate; wherein said alignment projection is formed on a surface of said second semiconductor substrate.

18. The light source device for an optical head apparatus according to claim 11 wherein said alignment projection comprises a third side surface for alignment of an optical element with said laser diode chip.

19. A method of aligning a laser diode chip of a light source device for an optical head apparatus according to claim 14, comprising the steps of:
pushing said first laser diode chip against said first side surface and said second side surface of said first projection; and
slidingly moving said second laser diode chip against said first side surface.
